(19) United States
(12) Patent Application Publication
(10) Pub. No.: US 2004/0079022 A1
(43) Pub. Date: Apr. 29, 2004

(54) Modular hookless lure system

(76) Inventors: Gerald Lee Owen, Reno, NV (US); Stephen Eric Penrose, Reno, NV (US)

Correspondence Address: Law Offices of John D. Gugliotta, PE, Esq., 202 Delaware Building, 137 South Main Street, Akron, OH, 44308, US

(21) Appl. No.: 10/689,750

(22) Filed: Oct. 22, 2003

Related U.S. Application Data
(63) Continuation-in-part of application No. 10/060,478, filed on Jan. 30, 2002.

(51) Int. Cl. A01K 85/00

(52) U.S. Cl. 43/42.09

(57) ABSTRACT

A modular hookless lure system is provided having a plurality of lure module elements. Each said lure module elements has a proximal end opposite a distal end, a tie eye affixed at the proximal end and a snap swivel affixed at the distal end. Functional lure element are supported on a wire between the two ends. Each tie eye can be attached to any existing fishing line and any said snap swivel can be removably attached to any selected hook of choice or any other said tie eye.

### RELATED APPLICATIONS

The present invention was first described in Disclosure Document Number 498,866 filed on Aug. 22, 2001 under 35 U.S.C. §122 and 37 C.F.R. §1.14, and is a Continuation in Part of U.S. Ser. No. 10/060,478, now under appeal.

### BACKGROUND OF THE INVENTION

1. Field of the Invention

The present invention relates generally to an assembled, hook-less fishing lure which ends with a snap swivel, thereby allowing the fisherman in the field to customize or adapt the lure so that it will attract a certain size, type, or species of fish desired. More particularly, this customizable lure system allows the fisherman to add additional lures elements to provide different visual or auditory stimulus and/or hooks of choice that will attract a certain size, type or species of fish.

2. Description of the Related Art

The technology used by anglers to catch fish has become increasingly complex in nature. Fishermen no longer rely on the traditional hook and worm approach to attract their game. Instead, a broad range of products have hit the market, designed to aid the fisherman to catch more fish quickly. One of the more popular aids is that of specialized lures designed to catch specific species of fish. While these lures do work remarkably well, they force the fisherman to purchase several different types of lures depending on the fish he or she is trying to catch. Additionally, these lures do not allow for any tweaking of the lure by adding specialized items to attract fish, particularly on the spur of the moment in the field.

The customizable lure invention will for the first time allow adaptation in the field of an assembled, hook-less lure. The customizable lure system invention is an assembled, hook-less lure ending with a snap swivel. The presence of a snap swivel at the end of the lure allows the fisherman to customize the assembled lure by adding another spinner/lure and/or hook of choice to meet specific conditions encountered in the field. This unique lure configuration ending with a snap swivel allows the fisherman to use a single lure to fish for any species under any conditions encountered in the field The invention is unique to the art.

A search of the prior art did not disclose any patents that read directly on the claims of the instant invention. However, of particular importance is known U.S. Pat. No. 5,634,290, issued in the name of Johnson. The Johnson invention describes a fishing lure device that teaches an interchangeable line segment, or customizable line harness (as distinguished from a customizable lure device), that allows for a customizable tying device which is used solely to attache variable bait to the fishing lure without the use of a snap swivel. The absence of a snap swivel prevents the fisherman from customizing or adapting the lure to meet various fishing conditions encountered in the field. Accordingly, the Johnson invention involves a customizable line system as distinguished from this invention which allows the lure to be customized to all fishing needs and conditions.

Consequently, there is a need for a fishing lure that is adaptable by the presence of a snap swivel at the end of the assembled, hook-less lure. This allows the angler to add his own hooks and/or additional lures or spinners to the snap swivel in the field under real-time fishing conditions to vary luring stimuli or otherwise change variables to conform with various fishing conditions, such as weather, light, temperature, or species of fish desired or encountered. This invention eliminates the need for the angler to carry many different specialized lures in the tackle box when one customizable lure system will meet all the fisherman to adapt to changing or differing conditions.

### SUMMARY OF THE INVENTION

It is therefore an object of the present invention to provide an improved fishing lure.

The main feature of the present invention provides a customizable lure system using a snap swivel on the end of the lure, thereby allowing the fisherman in the field to easily adapt the lure to specific uses and conditions by adding additional lures elements and/or hooks of choice to the snap swivel.

Briefly described according to one embodiment of the present invention, a customizable lure system is provided as an assembled fishing lure with enhanced features when compared to conventional fishing lures. This lure is unique in that the presence of a snap swivel on the end without a hook attachment allows the fisherman to quickly add additional lure elements in series, leader lines, and/or hooks of choice to catch a desired species of fish or to adjust to changing fishing conditions. The customizable nature of this lure allows the angler to catch any desired species or size of fish under any and all fishing conditions.

Another feature of the invention allows the fisherman to add a leader, hook, worm or bug to the lure at the snap swivel so that while trolling it attracts fish to the location of the bait by its vibrating and flashing action in the water.

Additionally, various leader lines and hooks can be attached to aid in attracting and catching fish trolling or fishing off the shore.

The use of the customizable lure system provides fishermen an increased chance of attracting various types of fish, and allows them an increased ability to set the hook and land them as well.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a top plan view of a lure module element 10 of the modular hookless lure system according to a preferred embodiment of the present invention;

FIG. 2 is a top plan view thereof shown attachable to a hook 20;

FIG. 3 is a top plan view thereof shown attachable to an alternate hook 22;

FIG. 4 is a top plan view thereof shown attachable to a leader line and hook combination 24;

FIG. 5 is a top plan view thereof shown attachable to a second modular lure element 10; and

FIG. 6 are plan views of various lure means components utilized by the customizable lure system of the present invention.

### DETAILED DESCRIPTION OF THE PREFERRED EMBODIMENTS

The best mode for carrying out the invention is presented in terms of its preferred embodiment, herein depicted within the Figures.

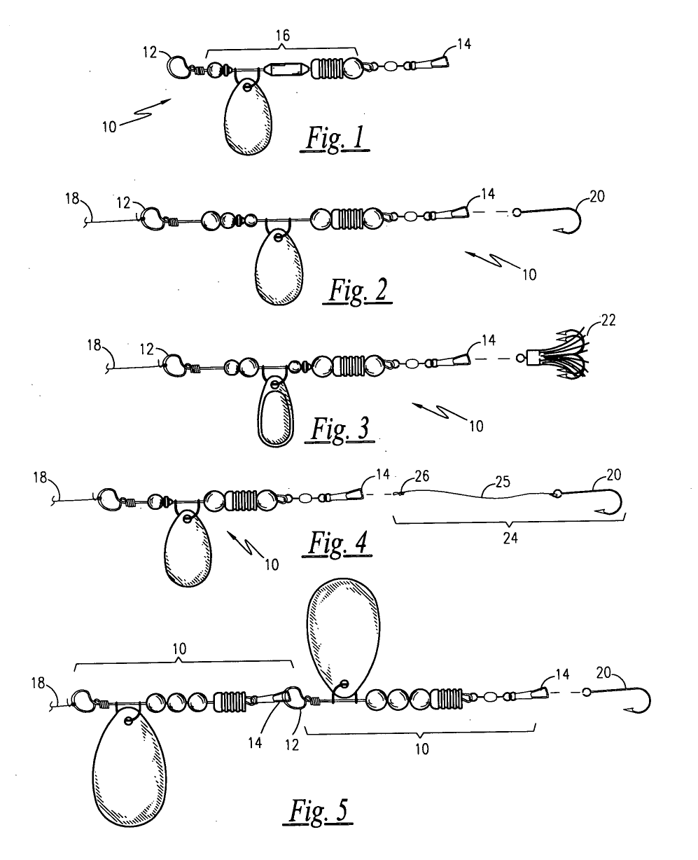

Referring now to FIGS. 1-5, a modular hookless lure system is disclosed utilizing a lure module element 10 as the foundation of a system of interchangeable, adaptable elements that allow various lure functionality to be incorporated, in situ, by the fisherman between any existing line and any selected hook of choice. In greater detail, each lure module element 10 has a proximal end opposite a distal end, and is formed of a tie eye 12 at the proximal end and a snap swivel 14 at the distal end. In between, and connecting the tie eye 12 to the snap swivel 14 is a lure means 16. Various elements and devices are known to lure game fish, and it is anticipated that many type of structural elements can form and create a luring attraction though the use of sound, sight, smell, vibration, or combinations thereof. However, it is of a particular importance to the practice of the present teachings that a variety of lure means devices, including various functional elements, be available among a plurality of such lure module elements 10. A selection of particular functional elements shall be described in greater detail below. Such ability to change, mix, match or combine such lure module elements 10 provides a fishing lure system with enhanced features when compared to conventional fishing lures.

As exemplary of the teachings of the present invention, FIG. 2 depicts a lure module element 10 shown having the tie eye 12 conventionally affixed to a fishing line 18 in any conventional manner, and having the snap swivel 14 attachable for use with an otherwise conventional hook 20. For purposes of contrast, FIG. 3 depicts the same configuration of lure module element 10 shown attached to an alternate hook 22. Such capability allows the user to attach any hook of choice to the lure by attachment to the snap swivel 14, while at the same time allowing removal of the hook and replacement by an alternately selected hook in an easy manner. This is done without removing the lure element 10 from the line 18 or otherwise disturbing the lure element 10 at all.

Similarly, FIG. 4 depicts a lure module element 10 wherein the snap swivel 14 is connectable to a leader line and hook combination 24 wherein the hook 20 is provided already attached to a length of leader line 25 and terminated to a connection eyelet 26. Such a capability allows the user to switch between conventional hooks 20 and leader style hook combinations 24 by attachment to the snap swivel 14, without removing from lure 10 from the line 18 or otherwise disturbing the lure element 10 at all.

Finally, in that it is anticipated that various modular lure elements 10 will each support different particular functional elements that are directed to either sight, sound or vibration functions, it is an integrally anticipated within the scope of the present invention that any number or combinations of modular lure elements 10 can be used together, as shown in FIG. 5. Such a series of modular lure elements 10 are formed by attachment of the tie eye 12 of a second modular lure element 10 to the snap swivel 14 of the first modular lure element 10. In this manner, the snap swivel 14 of the second modular lure element 10 is thereafter used for connection to any selected hook of choice 20.

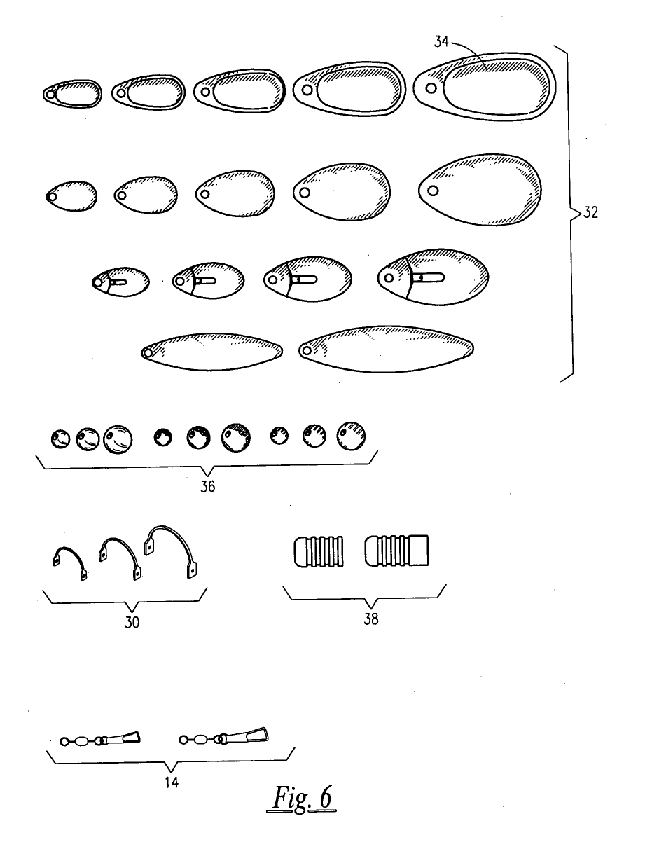

As described above, the manner of use, enablement and scope of the preferred embodiment are described in which each of a plurality of modular lure elements 10 are anticipated as being used in concert as a modular hookless lure system. The use and teachings herein are not anticipated as being dependant upon a specific configuration of any particular lure means 16. However, by way of example and enablement, and not as a limitation, it is felt that the lure means should include a selection of various components as selected from those shown in FIG. 6, including a clevis 30 of any type that would thread onto a 0.030 gauge wire and support a spoon, or blade 32 such as to form a spinner when drawn through the water. In that the differences in sizes of spoons or blades 32 can generate different frequencies of vibration or differences in motion, it is important to have lure element modules incorporating different such sizes to provide the user with the ability to change functional attraction means by replacing or combining such spinners. Further, it is anticipated that the blade surface 34 of different spoons or blades 32 can have different visual impressions, such as glossy or shiny, dull or dark, bright and colorful, metallic, etc. to allow the user with the ability to change functional attraction means by replacing or combining such spinners. Also anticipated are a variety of size and colored beads 36 and weighted bobs 38. Also anticipated is the use of snap swivels 14 of various capacity, i.e. different strengths such as to support tensile strengths of differing limits.

The heart of the invention remains an assembled lure module element 10 that provides a lure line terminated on one end by a snap swivel 14. The flexibility of this system allows the angler to adjust the vibrating and flashing mechanism during trolling. Additionally, various leader lines and hooks can be attached to the snap swivel 14 by the angler in the field to attract and catch fish as well. However, the presence or variation of all these components to the assembled customizable lure system is not essential. The essential component of the assembled configuration is the presence of a snap swivel on one end, and the absence of a hook.

As designed, customizable lure system has many features that make it beneficial to both consumers and manufacturers. It is utilized like any other lure, allowing the spinning motion to cause vibration and flashing that aid in attracting fish to the bait of choice. Its uniqueness when compared to other lures is that any of these various configurations can be modified by the user to allow the user to catch any size or species of fish under any conditions with the use of a single customizable lure system. As such, the lure is allowed to run deep or near surface of water by utilizing different lure elements that can be added to the end of the snap swivel 14 by user in field. Likewise, the user can easily change hooks, for example, to better enable him to attract and catch varying sizes and species of fish. By varying the size and type of elements attached to the snap swivel 14, the angler increases the chance of a strike and the likelihood of catching more fish. Hooks attached by the user via leader line, or multiple hooks therein attached, can be added to the invention by suspending them from the snap swivel on the customizable lure body.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A modular hookless lure system comprising:
a plurality of lure module elements, each said lure module elements having a proximal end opposite a distal end, a tie eye affixed at said proximal end and a snap swivel affixed at said distal end and lure means there between; wherein each said tie eye can be attached to any existing fishing line and any said snap swivel can be removably attached to any selected hook of choice or any other said tie eye.

2. The modular hookless lure system of claim 1, wherein said lure means is selected from the group of functional elements for creating a game fish attraction through the use of sound, sight, smell, or vibration.

3. The modular hookless lure system of claim 2, wherein said functional elements are selected from the group comprising: clevis; spoon or blade; beads; and weighted bobs.

4. A modular hookless lure system formed by a plurality of lure module elements, wherein at least one of said lure module elements comprises:
a proximal end opposite a distal end and separated by a wire,
a tie eye affixed at said proximal end for attachment to any existing fishing line;
lure means supported by said wire; and
a snap swivel affixed at said distal end, wherein said snap swivel can be removably attached to any selected hook of choice or any other said tie eye.

5. The modular hookless lure system of claim 4, wherein said lure means includes at least one functional element for creating a game fish attraction.

6. The modular hookless lure system of claim 5, wherein said lure means generates a luring stimulus selected from the group comprising: sound, sight, smell, and vibration.

7. The method of providing an interchangeable fishing lures that can be modified in-situ, said method comprising:
a. selection of a plurality of interchangeable, adaptable elements that allow various lure functionality to be incorporated by the fisherman between any existing line and any selected hook of choice;
b. Attachment of any said interchangeable, adaptable element to an existing fishing line; and
c. Selection of a hook; and
d. Attachment of said hook to said adaptable element.

8. The method of claim 7, wherein said interchangeable, adaptable element comprises:
a proximal end opposite a distal end and separated by a wire,
a tie eye affixed at said proximal end for attachment to any existing fishing line;
lure means supported by said wire; and
a snap swivel affixed at said distal end, wherein said snap swivel can be removably attached to any selected hook of choice or any other said tie eye.

9. The method of claim 8, wherein said lure means includes at least one functional element for creating a game fish attraction.

10. The method of claim 9, wherein said lure means generates a luring stimulus selected from the group comprising: sound, sight, smell, and vibration.
